(19) United States
(12) Patent Application Publication
(10) Pub. No.: US 2017/0240144 A1
(43) Pub. Date: Aug. 24, 2017

(54) DEVICE FOR CHANGING BRAKE OIL

(71) Applicant: COSDA MANUFACTURING COMPANY, Taichung City (TW)

(72) Inventor: Lai-Cheng LIU, Taichung City (TW)

(21) Appl. No.: 15/052,351

(22) Filed: Feb. 24, 2016

(51) Int. Cl. B60S 5/00; F16K 11/07; F16K 31/122; F16N 31/00

(52) U.S. Cl. CPC B60S 5/00; F16N 31/00; F16K 11/07; F16K 31/1221; F16N 2210/04

(57) ABSTRACT

A device for changing brake oil is provided. By utilizing a pneumatic multi-phase valve which is movable between a pressurizing position and a depressurizing position and automatically repositionable to the pressurizing position, a hydraulic cylinder is driven to carry out multiple times of intermittent oil-injections.

When a pressure inside the pneumatic valve position controlling assembly is smaller than or equal to a predetermined pressure, the pneumatic multi-phase valve is on the pressurizing position, and the hydraulic cylinder carries out the oil-injection. When the pressure inside the pneumatic valve position controlling assembly is greater than the predetermined pressure, the valve member is on the depressurizing position, and the hydraulic cylinder does not carry out the oil-injection.

### BACKGROUND OF THE INVENTION

Field of the Invention

The present invention relates to a device for changing brake oil.

Description of the Prior Art

Usually, if a vehicle is often used or carries heavy objects, an inertia momentum is relatively greater; therefore, a friction needed for braking is greater, a burden to a braking system increases, and a brake oil reaches a boiling point easily so that a braking force decays. Hence, the brake oil ages quickly, and the brake oil needs to be changed after the vehicle is used for a certain period of time or a certain distance so as to ensure a braking security.

However, it usually requires at least two persons to change the brake oil, one stamps a brake, and the other needs to cooperate with the one stamping the brake to control a leakage of the brake oil. A user pressurizes and injects oil into a brake oil way system through stamping and releasing the brake to change the brake oil, and air can be prevented from entering a braking oil tube to affect a braking function. It is inconvenient and efficient to change the brake oil in the conventional way.

The present invention has arisen to mitigate and/or obviate the afore-described disadvantages.

### SUMMARY OF THE INVENTION

The major object of the present invention is to provide a device for changing brake oil which automatically conducts intermittent oil-injection and can adjust and control a speed and a rate of the oil-injection in accordance with different types of vehicles, braking cylinder systems or any pressure requirements.

A device for changing brake oil of the present invention is provided, including a pneumatic multi-phase valve, pneumatic valve position controlling assembly, a pneumatic cylinder, a hydraulic cylinder and an oil-supplying valve assembly. The pneumatic multi-phase valve has an air inlet passage for being connected to a pressure source, an air outlet passage, a depressurizing passage, a valve member which is movable among the air inlet passage, the air outlet passage and the depressurizing passage and a valve position controlling passage communicating with the air inlet passage, and the valve member is movable between a pressurizing position and a depressurizing position and is automatically repositionable to the pressurizing position. The pneumatic valve position controlling assembly includes a speed-adjusting depressurizing mechanism which is controllably communicated with and between the air outlet passage and the valve position controlling passage. The pneumatic cylinder pneumatically communicates with the air outlet passage. The hydraulic cylinder is driven by the pneumatic cylinder. The oil-supplying valve assembly includes a pressurizing passage communicating with the hydraulic cylinder, an oil-sucking passage for being connected to a brake oil source and an oil-exporting passage for being connected to an oil-injection space. when a pressure inside the pneumatic valve position controlling assembly is smaller than or equal to a predetermined pressure, the valve member is on the pressurizing position, the depressurizing passage and the air inlet passage are non-communicated with each other, the air outlet passage and the air inlet passage communicate with each other to allow air to enter the pneumatic cylinder; when the pressure inside the pneumatic valve position controlling assembly is greater than the predetermined pressure, the valve member is on the depressurizing position, the air outlet passage and the air inlet passage are non-communicated with each other so that air cannot enter the pneumatic cylinder, and the depressurizing passage and the air inlet passage communicate with each other to allow air to be exhausted to outside.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIG. 2 is a top view of the preferred embodiment of the present invention;

FIGS. 3A and 3B are cross-sectional views of a pneumatic multi-phase valve of the preferred embodiment of the present invention;

FIG. 4 is a cross-sectional view of a pneumatic cylinder and a hydraulic cylinder of the preferred embodiment of the present invention;

FIG. 5 is a drawing showing a structural relation of the preferred embodiment of the present invention; and

FIGS. 6 and 7 are block diagrams of the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

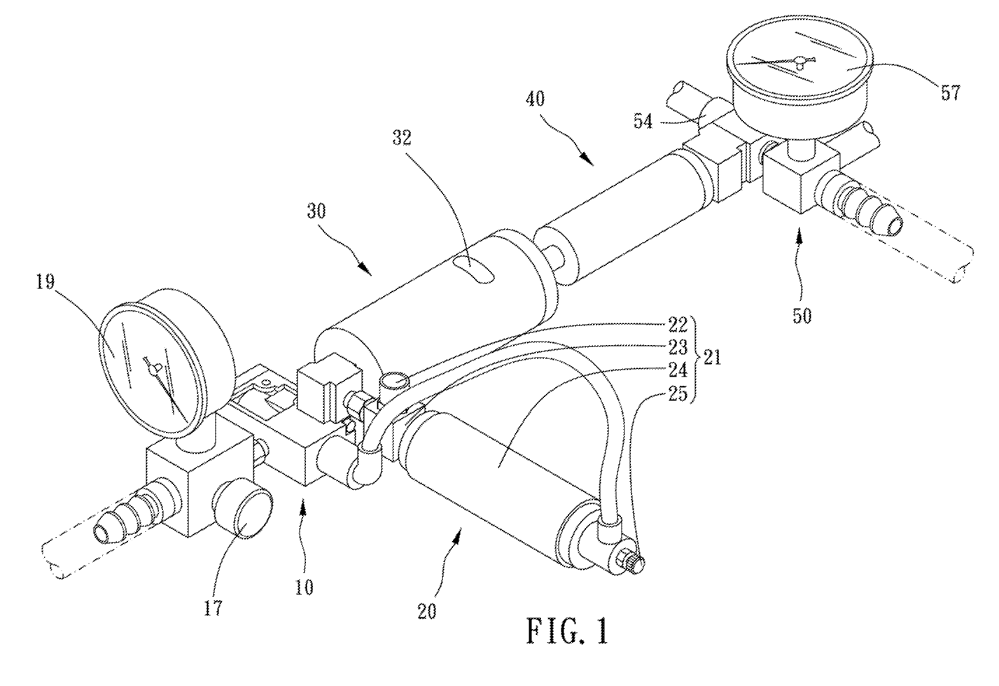

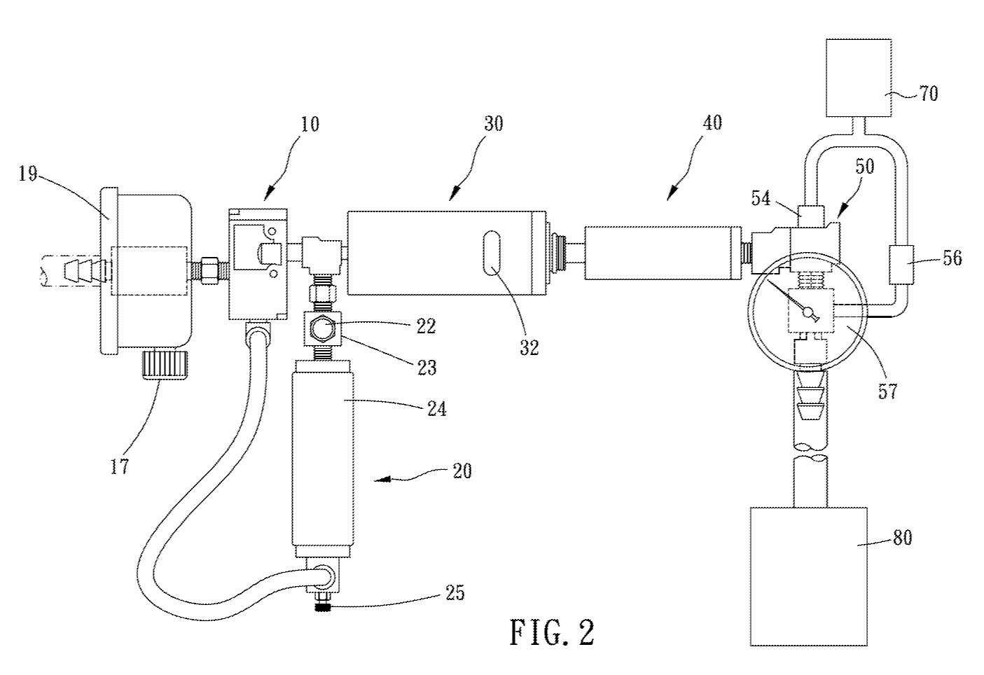

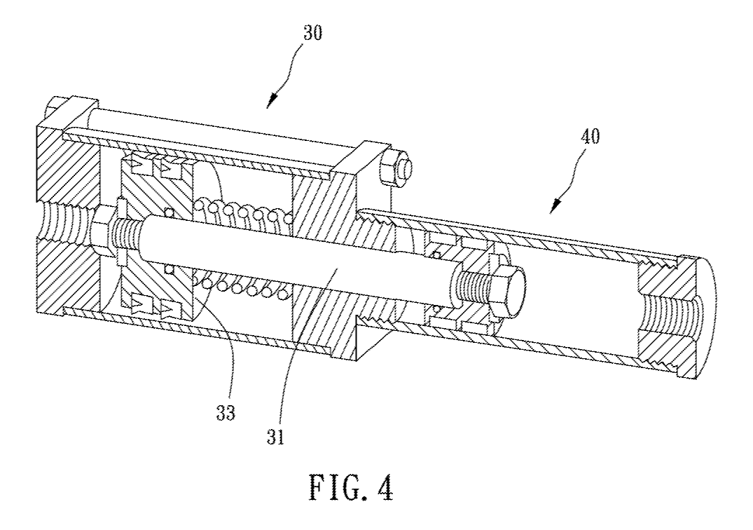

Please refer to FIGS. 1, 2, 3A, 3B, 4 and 5 for a device for changing brake oil of the present invention, including a pneumatic multi-phase valve 10, a pneumatic valve position controlling assembly 20, a pneumatic cylinder 30, a hydraulic cylinder 40 and an oil-supplying valve position assembly 50.

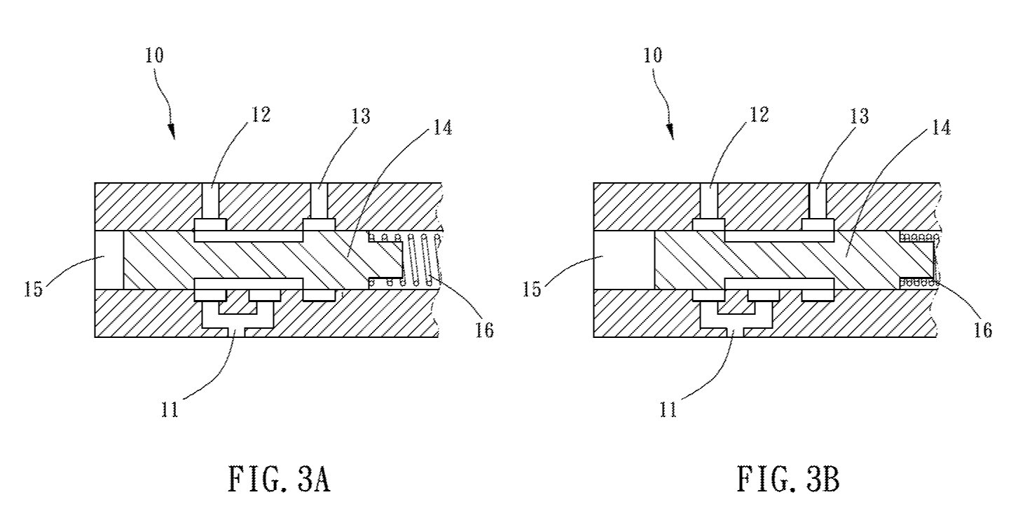

The pneumatic multi-phase valve 10 has an air inlet passage 11 for being connected to a pressure source 60, an air outlet passage 12, a depressurizing passage 13, a valve member 14 which is movable among the air inlet passage 11, the air outlet passage 12 and the depressurizing passage 13 and a valve position controlling passage 15 communicating with the air inlet passage 11, and the valve member 14 is movable between a pressurizing position (as shown in FIG. 3A) and a depressurizing position (as shown in FIG. 3B) and is automatically repositionable to the pressurizing position. In this embodiment, the pneumatic multi-phase valve 10 is a pneumatic 3/2-way valve which can be activated via an air pressure of the pressure source 60. Specifically, the pneumatic multi-phase valve 10 further includes an elastic member 16 (for example, a spring) disposed on a side of the valve member 14, and the elastic member 16 provides a reposition force to force the valve member 14 to automatically reposition to the pressurizing position.

A pressure-adjusting valve 17 is further connected between the pneumatic multi-phase valve 10 and the pressure source 60, and a manual 3/2-way valve 18 is further connected between the pressure-adjusting valve 17 and the pressure source 60. Therefore, during an operation process, a user can optionally guide an air from the pressure source 60 to the pneumatic multi-phase valve 10 or block the air via the manual 3/2-way valve 18, and the user can adjust or set the air pressure toward the pneumatic multi-phase valve 10 via the pressure-adjusting valve 17. Preferably, a first pressure gauge 19 is arranged between the pressure-adjusting valve 17 and the air inlet passage 11, and the user can know and control a pressure value via the first pressure gauge 19.

The pneumatic valve position controlling assembly 20 includes a speed-adjusting depressurizing mechanism 21 which is controllably communicated with and between the air outlet passage 12 and the valve position controlling passage 15. Specifically, the speed-adjusting depressurizing mechanism 21 includes a first speed-adjusting depressurizer 22 which is connected between the air outlet passage 12 and the valve position controlling passage 15, a first unidirectional valve 23 which is connected between the air outlet passage 12 and the first speed-adjusting depressurizer 22 and a container 24 which is connected between the first speed-adjusting depressurizer 22 and the valve position controlling passage 15, and the first unidirectional valve 23 allows air to flow to the container 24.

Preferably, the speed-adjusting depressurizing mechanism 21 further includes a second speed-adjusting depressurizer 25 which is connected between the container 24 and the valve position controlling passage 15, and the second speed-adjusting depressurizer 25 can adjust or set the air pressure from the valve position controlling passage 15 to the pneumatic multi-phase valve 10 so as to control conditions of the valve member 14 moving from the pressurizing position toward the depressurizing position (also controlling a communication frequency of the air outlet passage 12 and the air inlet passage 11, and controlling air circulation and pressure).

The pneumatic cylinder 30 pneumatically communicates with the air outlet passage 12. When the air outlet passage 12 communicates with the air inlet passage 11, the pneumatic cylinder 30 can be driven by air to export power through an output shaft 31. In this embodiment, a wall of the pneumatic cylinder 30 is formed with at least one port 32 communicating with outside, and a piston 33 inside the pneumatic cylinder 30 can move back and forth smoothly.

The hydraulic cylinder 40 is driven by the pneumatic cylinder 30. Specifically, the hydraulic cylinder 40 is coaxially connected to the output shaft 31 of the pneumatic cylinder 30 so as to co-move with the output shaft 31. It is understandable that the hydraulic cylinder 40 may be driven in other ways. For example, the hydraulic cylinder 40 may not be connected to the output shaft 31 of the pneumatic cylinder 30 directly but driven by an appropriate transmission mechanism such as a gear set, and a design may vary in accordance with different requirements.

The oil-supplying valve assembly 50 includes a pressurizing passage 51 communicating with the hydraulic cylinder 40, an oil-sucking passage 52 for being connected to a brake oil source 70 and an oil-exporting passage 53 for being connected to an oil-injection space 80. The brake oil source 70 is a brake oil barrel, and the brake oil source 70 may be any space or device which can receive oil. The oil-supplying valve assembly 50 further includes a second unidirectional valve 54 and a third unidirectional valve 55, the second unidirectional valve 54 is connected to the oil-sucking passage 52 and the pressurizing passage 51, the second unidirectional valve 54 allows a brake oil to flow to the pressurizing passage 51, the third unidirectional valve 55 is connected to the pressurizing passage 51 and the oil-injection space 80, and the third unidirectional valve 55 allows the brake oil to flow to the oil-injection space 80 (in this embodiment, the oil-injection space 80 is an interior space of a brake master cylinder, and the oil-injection space 80 may be any space which requires oil-injection). Preferably, the oil-supplying valve assembly 50 further includes an unidirectional reverse pressure releasing valve 56 which is connected between the third unidirectional valve 55 and the oil-injection space 80, and the unidirectional reverse pressure releasing valve 56 allows the brake oil to flow to the brake oil source 70 (it is to be noted that the brake oil source 70 connected to the second unidirectional valve 54 and the brake oil source 70 connected to the unidirectional reverse pressure releasing valve 56 may be the same oil-containing device and may be two independent oil-containing devices). Preferably, a second pressure gauge 57 may be arranged between the third unidirectional valve 55 and the oil-injection space 80, and the user can know and control a hydraulic value, which is adjusted, via the second pressure gauge 57.

when a pressure inside the pneumatic valve position controlling assembly 20 is smaller than or equal to a predetermined pressure (can be set by the user), the valve member 14 is on a pressurizing position, the depressurizing passage 13 and the air inlet passage 11 are non-communicated with each other, the air outlet passage 12 and the air inlet passage 11 communicate with each other to allow air to enter the pneumatic cylinder 30; when the pressure inside the pneumatic valve position controlling assembly 20 is greater than the predetermined pressure, the valve member 14 is on the depressurizing position, the air outlet passage 12 and the air inlet passage 11 are non-communicated with each other so that air cannot enter the pneumatic cylinder 30, and the depressurizing passage 13 and the air inlet passage 11 communicate with each other to allow air to be exhausted to outside.

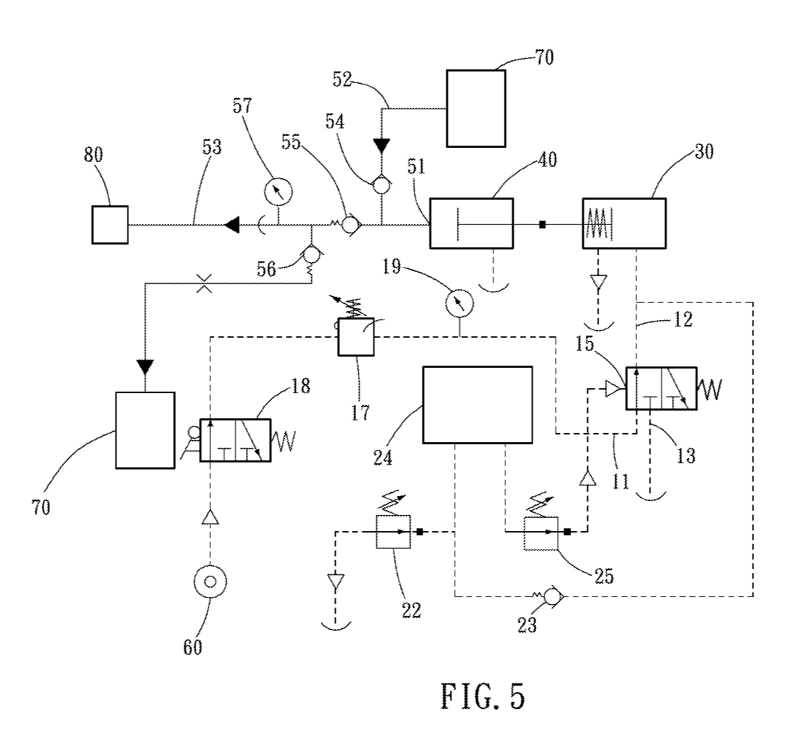

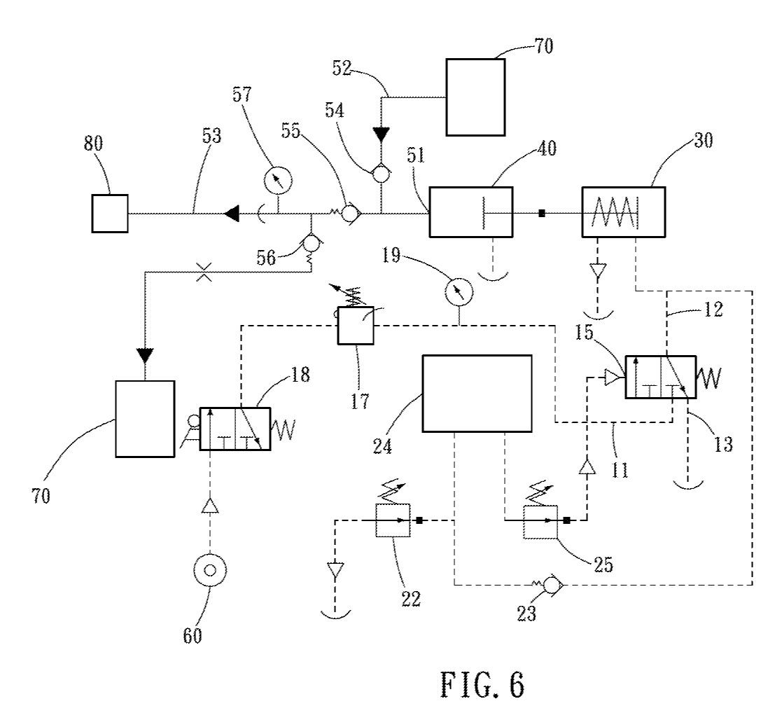

Please further refer to FIGS. 5 to 7. In actual practice, as shown in FIGS. 5 and 6, the user can manually open the manual 3/2-way valve 18 to allow air to pass therethrough and use the pressure-adjusting valve 17 with the first pressure gauge 19 to control the pressure entering from the air inlet passage 11 into the pneumatic multi-phase valve 10. In the initial state, the elastic member 16 forces the valve member 14 to have a tendency to move toward the pressurizing position, and air can enter from the air inlet passage 11, through the air outlet passage 12 and into the pneumatic cylinder 30; in the meanwhile, air flows through an air passage which communicates with the air outlet passage 12 and passes through the first unidirectional valve 23, and a speed and a pressure of air entering the container 24 are controlled via the first speed-adjusting depressurizer 22. After air passes through the container 24, the speed and the pressure of air entering the valve position controlling passage 15 are controlled via the second speed-adjusting depressurizer 25, and air entering from the valve position controlling passage 15 applies to the valve member 14 with a force toward the depressurizing position.

Air entering the pneumatic cylinder 30 pushes the piston 33 inside the pneumatic cylinder 30 to move, activates the output shaft 31 to drive the hydraulic cylinder 40 (the user can know a pressure value of oil-injection through a cooperation of the second pressure gauge 57), and makes the brake oil pass through the third unidirectional valve 55 via the pressurizing passage 51 and flow into the oil-injection space 80 (the brake master cylinder).

When the hydraulic cylinder 40 is pressurized, the air pressure inside the pneumatic valve position controlling assembly 20 increases, the air pressure is applied to the valve member 14 with a force toward the depressurizing position, and air entering from the valve position controlling passage 15 is also applied to the valve member 14. When the air pressure inside the pneumatic valve position controlling assembly 20 is greater than the predetermined pressure, the valve member 14 is pushed to the depressurizing position; therefore, air can be exhausted to outside. In the meanwhile, the pneumatic cylinder 30 pulls the hydraulic cylinder 40 back to produce a suction force to suck the brake oil to pass the second unidirectional valve 54 through the sucking passage 52 and enter the pressurizing passage 51 for next pressurizing oil-injection. After depressurizing, the air pressure inside the pneumatic valve position controlling assembly 20 is smaller than the predetermined pressure, and the elastic member 16 pushes the valve member 14 to reposition to the pressuring position to accomplish an oil-injection process. It is to be noted that through the above mechanism, the device for changing brake oil can automatically conduct multiple oil-injection processes (in accordance with different requirements and pressure-adjusting settings, and more than 10 times of oil-injection processes can be accomplished per second), until the oil-injection space 80 is injected with oil.

When the oil-injection space 80 has been injected with oil (for example, the brake master cylinder will close an oil leaking opening after the oil-injection process has been accomplished), the device for changing brake oil may still be operating; therefore, the brake oil cannot be injected into the oil-injection space 80, the unidirectional reverse pressure releasing valve 56 provides a path which allows the brake oil to flow to an oil-collection space 90 (the brake oil barrel, and may be the same device as the brake oil source 70).

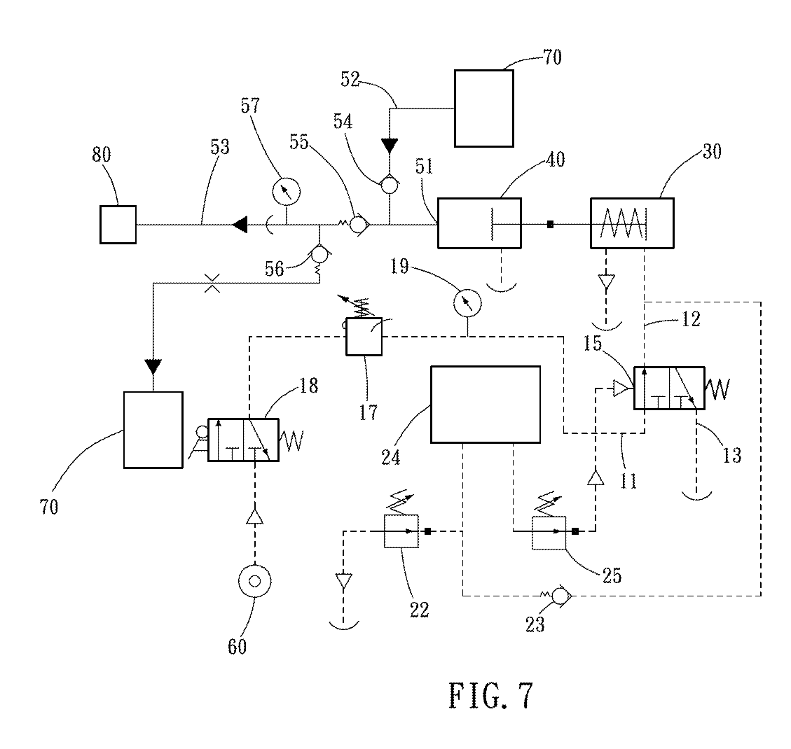

As shown in FIG. 7, finally, when all oil-injection processes are accomplished, the manual 3/2-way valve 18 is closed to stop providing air, the elastic member 16 abuts against the valve member 14 to make it reposition to the pressurizing position, and the pneumatic cylinder 30 and the hydraulic cylinder 40 return to states which are not pressurized.

Given the above, the device for changing brake oil can automatically conduct intermittent oil-injection, and multiple oil-injections can be carried out per second. It is convenient and quick to changing brake oil with the present invention.

In addition, through the pressure-adjusting valve and the speed-adjusting depressurizing mechanism 21, the user can adjust and control the speed and the rate of oil-injection in accordance with different vehicle types, brake cylinder systems or pressure requirements.

Furthermore, a structure of the present invention is simple and dismountable, so it is convenient to be manufactured, mounted, exchanged and maintained.

While we have shown and described various embodiments in accordance with the present invention, it should be clear to those skilled in the art that further embodiments may be made without departing from the scope of the present invention.

What is claimed is:

1. A device for changing brake oil, including:
a pneumatic multi-phase valve, having an air inlet passage for being connected to a pressure source, an air outlet passage, a depressurizing passage, a valve member which is movable among the air inlet passage, the air outlet passage and the depressurizing passage and a valve position controlling passage communicating with the air inlet passage, the valve member being movable between a pressurizing position and a depressurizing position and automatically repositionable to the pressurizing position;
a pneumatic valve position controlling assembly, including a speed-adjusting depressurizing mechanism which is controllably communicated with and between the air outlet passage and the valve position controlling passage;
a pneumatic cylinder, pneumatically communicating with the air outlet passage;
a hydraulic cylinder, driven by the pneumatic cylinder;
an oil-supplying valve assembly, including a pressurizing passage communicating with the hydraulic cylinder, an oil-sucking passage for being connected to a brake oil source and an oil-exporting passage for being connected to an oil-injection space;
wherein when a pressure inside the pneumatic valve position controlling assembly is smaller than or equal to a predetermined pressure, the valve member is on the pressurizing position, the depressurizing passage and the air inlet passage are non-communicated with each other, the air outlet passage and the air inlet passage communicate with each other to allow air to enter the pneumatic cylinder; when the pressure inside the pneumatic valve position controlling assembly is greater than the predetermined pressure, the valve member is on the depressurizing position, the air outlet passage and the air inlet passage are non-communicated with each other so that air is unallowable to enter the pneumatic cylinder, and the depressurizing passage and the air inlet passage communicate with each other to allow air to be exhausted to outside.

2. The device for changing brake oil of claim 1, wherein the pneumatic multi-phase valve is a pneumatic 3/2-way valve.

3. The device for changing brake oil of claim 1, wherein the pneumatic multi-phase valve further includes an elastic member disposed on a side of the valve member, and the elastic member provides a reposition force to force the valve member to automatically reposition to the pressurizing position.

4. The device for changing brake oil of claim 1, wherein a pressure-adjusting valve is further connected between the pneumatic multi-phase valve and the pressure source.

5. The device for changing brake oil of claim 4, wherein a manual 3/2-way valve is further connected between the pressure-adjusting valve and the pressure source.

6. The device for changing brake oil of claim 1, wherein the speed-adjusting depressurizing mechanism includes a first speed-adjusting depressurizer which is connected between the air outlet passage and the valve position controlling passage.

7. The device for changing brake oil of claim 6, wherein the speed-adjusting depressurizing mechanism further includes a first unidirectional valve which is connected between the air outlet passage and the first speed-adjusting depressurizer and a container which is connected between the first speed-adjusting depressurizer and the valve position controlling passage, and the first unidirectional valve allows air to flow to the container.

8. The device for changing brake oil of claim 7, wherein the speed-adjusting depressurizing mechanism further includes a second speed-adjusting depressurizer which is connected between the container and the valve position controlling passage.

9. The device for changing brake oil of claim 1, wherein the oil-supplying valve assembly includes a second unidirectional valve and a third unidirectional valve, the second unidirectional valve is connected to the oil-sucking passage and the pressurizing passage, the second unidirectional valve allows a brake oil to flow the pressurizing passage, the third unidirectional valve is connected to the pressurizing passage and the oil-injection space, and the third unidirectional valve allows the brake oil to flow to the oil-injection space.

10. The device for changing brake oil of claim 1, wherein the oil-supplying valve assembly further includes a unidirectional reverse pressure releasing valve connected between the third unidirectional valve and the oil-injection space, and the unidirectional reverse pressure releasing valve allows a brake oil to flow to the oil-injection space.
